(19) United States
(12) Patent Application Publication
(10) Pub. No.: US 2025/0389479 A1
(43) Pub. Date: Dec. 25, 2025

(54) RAPID REFRIGERATION DEVICE FOR PACKAGED BEVERAGES ADAPTABLE TO A KITCHEN APPLIANCE AND A METHOD OF REFRIGERATION

(71) Applicant: Juan Carlos Montes Galarza, Valle del Cauca (CO)

(72) Inventor: Juan Carlos Montes Galarza, Valle del Cauca (CO)

(21) Appl. No.: 19/305,294

(22) Filed: Aug. 20, 2025

Related U.S. Application Data
(63) Continuation of application No. PCT/CO2023/000003, filed on Apr. 24, 2023.

(30) Foreign Application Priority Data
Mar. 30, 2023 (CO) NC2023/0004121

(51) Int. Cl. F25D 31/00

(52) U.S. Cl. CPC F25D 31/002

(57) ABSTRACT

A device where a user of a kitchen appliance can quickly cool a bottled drink. The device has a cylindrical container, in which a bottled drink is inserted and positioned. The cylindrical container has at least one fastening mechanism that holds and secures the drink. An example of the appliance may be a blender or a food processor that includes a base, a rotary motor, a bowl, a lid and a function control panel. The cylindrical container is coupled to the appliance bowl by a mounting assembly that rotates together with the vertical shaft of the kitchen appliance rotary motor. The bottled drink is coupled to the fastening mechanism. A cooling medium consisting of iced water is poured into the appliance bowl and covered in order to be rotated at speed intervals or short pulses of 300 to 2500 revolutions per minute (RPM) to quickly cool the bottled drink.

### CROSS-REFERENCE TO RELATED APPLICATIONS

This application is a bypass continuation of International Application No. PCT/CO2023/000003, filed Apr. 24, 2023, which claims priority to Colombian Patent Application No. NC2023/0004121, filed Mar. 30, 2023, the disclosures of which are herein incorporated by reference in their entirety.

### TECHNICAL FIELD

This invention relates generally to the field of kitchen appliances. More specifically, the present invention refers to a device adjustable to a kitchen appliance used for rapidly cooling packaged beverages, therefore providing a simple mechanism for promptly cooling packed liquids.

### BACKGROUND OF THE INVENTION

A wide variety of kitchen appliances which contain a rotary motor, a receptacle, a base, and a function control panel, are now being used in many homes worldwide. For example, conventional blenders can be utilized mainly for integrating and mixing food or beverages. We can also find food processors, which are household devices used for chopping, cutting, slicing or mixing a variety of ingredients such as vegetables, fruits or meats. Such appliances: the blender, the food processor and many others, like a kitchen robot, use certain types of blades that are connected to a shaft powered by a rotary motor that is usually included in the appliance.

Additionally, in recent years, many of the appliances incorporate some additional features that improve the experience in the kitchen: for example, there are blenders with specific programming driven by a control panel that includes functionalities like processing food, making smoothies or frozen drinks, among other tasks that enhance and improve the user's experience. There is also a great variety of devices or accessories adapted to kitchen appliances, namely: juicers, filters, blades, slicers, dough blades, etc., which, with a specific routine of time and revolutions, make these kitchen appliances a very versatile tool using the same rotary motor. In the State of the Art, however, there is no device or accessory for these kitchen appliances that, together with a control method or routine, can cool our packaged beverages in a fast and simple way.

On the other hand, there are beverages stored in glass, plastic or aluminum cans for natural juices, carbonated sodas, or alcoholic spirits, such as beer. In order to get packed beverages cold, traditional methods are used (like conventional refrigeration units or coolers), which means waiting up to five hours or more to reach an ideal low temperature for our packaged drink, a time too long that creates the need to use an alternative method where we add ice to the brews or use cooling devices designed to refrigerate packaged potables that are currently in the State of the Art but do not generate the desired results of a sufficiently cold drink.

As mentioned above, in the current State of the Art, there are several methods or devices that have endeavored to improve the difficulties presented by these refrigeration units intended for cooling liquids and packaged beverages. These techniques have significantly improved the cooling time of the drink (from hours to minutes), achieving a temperature under 15° C. of, for example, an aluminum can. These devices are designed solely and exclusively to fulfil this function. Examples of them can be found, in some patents, such as U.S. Pat. No. 7,707,848 B2, which discusses a rapid fluid cooler and its method, or U.S. Pat. No. 5,505,054 by Loibl Gregory H and George Sidebotham, which discloses a fast fluid cooling system with a refrigeration device inside, or U.S. Pat. No. 9,845,988 B2 by Douglas Shuntich, which addresses a quick-turn liquid immersion beverage super refrigerator. The purpose of these current techniques, is to cool the beverage by swirling it inside a container of iced water, optionally including salt, and operated utilizing motors and spray pumps.

Other current techniques include those described in U.S. Pat. No. 10,190,818 B2 by Tyler Scott Parker and Trevor William Abbott, which discloses a container spinning device and its method of use, as well as U.S. Pat. No. 7,637,120 B1 by Brian Edward Doss, which describes a vessel clamping mechanism. These techniques involve devices that operate in conjunction with another gadget or directly on ice containers, requiring a rotary motor for their function. Although their design is simple and practical, they tend to lack durability and demand greater physical effort from the user, who must manually enable the cooling effect, specifically, by holding the device while the thermal exchange occurs. Furthermore, during operation, the user is exposed to splashes of ice water caused by the motor's speed.

Although these techniques are effective, they are limited because they only perform one function, generating a waste of space that may be used more productively in the kitchen. In addition, some of these techniques are not suitable for certain types of packaged beverages or do not provide sufficient cooling in a short period of time. Consequently, the appliances used for these purposes might require additional kitchen space that could be used more productively.

Within the processes or thermodynamic media used, the concept of using the vortex as a thermodynamic tool was also found and is used in a variety of devices and appliances for cooling and mixing beverages in any type of container. An example of this is the aforementioned: U.S. Pat. No. 5,505,054. The term vortex is a mathematical concept used in fluid dynamics that can be related to the amount of circulation or rotation of a fluid. That generates the thermal exchange of the contained fluids causing them to lose heat rapidly upon contact with a cooling mean.

For these reasons, we believe that enabling the use of a kitchen appliance-such as a blender, food processor, or kitchen robot-in conjunction with a dedicated device and a programmed routine in its control panel, to rapidly cool packaged beverages without user effort or exposure to splashing, constitutes the solution to a long-felt, unresolved need and therefore advances the field.

### SUMMARY OF THE INVENTION

The present invention regards a device in which a user of a kitchen appliance can rapidly cool a packaged beverage. This gadget can be adapted to any type of household appliance comprising a rotary motor, a base, a function control panel, a lid and a container, such as blenders, food processors, and kitchen robots, among other domestic appliances. The cooling device holds the beverage container (such as aluminum cans, glass or plastic bottles containing liquids like soft drinks, juices, beers, among others); while it is spun by the vertical axis of the rotary motor of the appliance, driving the beverage to be cooled using the vortex concept. For this purpose, the device has a cylindrical container where the packaged product to be cooled is introduced and positioned, which also has at least one clamping mechanism that holds and secures the bottled drink inside the cylindrical container. The latter is coupled to the device's vessel through a mounting set which rotates in accordance with the vertical axis of the appliance's rotary engine so that the movement is determined by the whirl of the motor. The cylindrical container is adjustable to accommodate a variety of beverage container sizes, including 0.266, 0.355, or 0.473-liter cans (9, 12, or 16 ounces), 0.325 or 0.739-liter bottles (11 or 25 ounces), or other container dimensions. The height of the cylindrical container may vary depending on its design, as beverage containers come in widely diverse sizes. Additionally, the appliance's container must seal properly to ensure the process functions without water leaks.

The cylindrical container may be connected to the mounting set using an assembly base. Said assembly support may be integrated into the cylindrical receptacle as one piece, or it may be integrated into the assembly base in a removable manner through an internal and external threaded connection, where an internal threaded mechanism is arranged on the assembly base and an exterior threaded mechanism is positioned on the underside of the cylindrical container, or vice versa, allowing them to be joined in both directions. Such an internal and external threaded connection may be configured for some types of household appliances that need to insert the mounting set into the device and, subsequently, must connect the cylindrical container to the mounting set.

The assembly base may be integrated into the mounting set through an affixing element which may be a fastener, such as, for example, a screw, a nut, a rivet, a bolt, a quadrant arm stay, or simply via a welding process that joins and integrates the mentioned assembly base and the corresponding mounting set. Hence, the assembly base may have a central flange comprising a quadrant arm stay into which the fastener fits. That flange is configured to reinforce the assembly base making the fastening element much tighter. It should be specified that the mounting set can be made of any shape, size, material or type of mounting assembly that fits the domestic appliance used so that the present invention works correctly.

The cylindrical container comprises a set of heat exchange orifices arranged around it to allow a cooling means to come into direct contact with the packaged beverage and to generate a turbulent rotation increasing the possibilities of producing a thermal exchange in a faster way. The orifices are distributed in any manner, provided that at least one edge of the cylindrical container remains free to attach the clamping mechanism. Each heat exchange orifice of the cylindrical container may comprise any desired shape and configuration, such as, for example, some oval, rectangular, triangular, circular, or other similar shapes or, as shown in the figures, in an elliptical shape.

The present invention also comprises at least one clamping mechanism configured to hold, adjust and tighten any packaged beverage variety so that it rotates at the same speed, time, and direction as the vertical axis of the rotary motor of the appliance. Said clamping mechanism is arranged within the cylindrical container, either press-fitted, glued, riveted, screwed, or assembled to the cylindrical container. It should be noted that in the description of the figures, a variety of embodiments are illustrated in which additional elements may be required to be useful for the manufacture of the present invention.

For example, in some embodiments, the clamping mechanism may consist of a circular ring with a tab set that presses the packaged beverage toward the center of the beverage container. Another example of a clamping mechanism that we can see in detail in the following figures consists of a fastening cover. This time the fastening cover generates a downward pressure that positions and adjusts the beverage container inside the cylindrical container. This realization may include, for example, an elastic element that increases the pressure of the packaged beverage remaining fixed to the cylindrical container. As stated above, these and other embodiments will be explained in detail in the description of the figures and constitute examples of fastening mechanisms which may be used in the development of the present invention.

The cylindrical container and other parts of the cooling device can be re-elaborated or manufactured with compound polymers by extrusion or injection molding. However, any different material can also be used, such as stainless steel, aluminum, and plastic, among other materials resistant to low temperatures and to the rotational force of the motor of a household appliance.

In order to achieve adequate refrigeration for the packaged beverage, the cooling device should be rotated at a certain speed ranging preferably from 300 to 2500 RPM in time intervals or pulses of one to three seconds, completing an approximate time between thirty to one hundred and eighty seconds for an effective cooling depending on the material of the container (glass, aluminum or plastic). Therefore, a programmed pulse routine can be implemented for this invention at timed intervals. Consequently, one of the commands that work within the control panel of a home appliance can be adapted, such as the food processing function, modifying or extending the duration that this function generally already contains, or adding a configuration that understands a routine with a specific schedule where it includes the number of pauses or the number of seconds, or cycles during a specific time.

Some appliances also include a slush button or a manual use of the pulse function, which adapts to a desirable and safe speed (RPM) in defined intervals that can be used for the correct operation of the present invention. This pulse function allows a user to determine the duration of it to their consideration and preference, which allows a more personalized cooling since the cycle rotation time is related to the temperature that a user wants to reach. Therefore, it can be argued that the longer the cycle process time and rotation pulses of the device, the greater the cooling the packaged beverage will reach.

The cylindrical container with the mounting set is inserted and positioned within the household appliance container, where the mounting set is fitted to the household appliance container to engage on the vertical axis of the rotary motor of the home device. The packaged beverage enters the appliance container, is nested inside the cylindrical container, and gets secured with the clamping mechanism. The appliance container is filled with a cooling means made up of a mixture of iced water that reaches the lowest possible temperature. In general, ice maintains a temperature of around 0° C., which helps to refrigerate the packaged drink. A considerable amount of salt can be added to the ice and water mixture, since it allows for much greater cooling. The appliance container is closed to avoid possible spills and start the activation of the command with the specific routine and the rotation of the motor, which makes the cylindrical container rotate as the clamping mechanism holds the packaged beverage. When the selected programmed routine ends, the cold packaged beverage can be withdrawn so a new packaged drink can be placed for cooling, or the device mounting set can be removed to finish the process. Due to centrifugal force of the appliance's motor, which, in conjunction with the specific routine, set at a preferable speed range of between 300 to 2500 RPM, the thermal exchange can be achieved. In this way, the cooling effect is generated in the packaged drinks. The rotation produces a thermal shift from the center to the wall of the packed beverage, causing their refrigeration in approximately thirty to sixty seconds for aluminum cans or one to three minutes for glass bottles, a substantial benefit for lovers of cold drinks.

It should be noted that one of the advantages of the present invention is to enhance the functions of household appliances, generating added value that complements their functionalities and benefits. Likewise, the conception of the present invention allows it to be used as a basis for the design of other structures, containers, methods, and mechanisms to perform the purposes of the invention.

### BRIEF DESCRIPTION OF THE DRAWINGS

FIG. 1 is a perspective view of an embodiment of a rapid refrigeration device for packaged beverages in accordance with the present invention.

FIG. 2 is a perspective view of an embodiment of a rapid refrigeration device for packaged beverages in accordance with the present invention in conjunction with a kitchen appliance.

FIG. 3 is an exploded view of an embodiment of a rapid refrigeration device for packaged beverages in accordance with the present invention in conjunction with a kitchen appliance.

FIG. 4 is a perspective view of a cylindrical container holding a packaged beverage in accordance with the present invention.

FIG. 5 is an exploded view of the cylindrical container in conjunction with the mounting set according to an embodiment of the present invention.

FIG. 6 is an exploded view of the cylindrical container in conjunction with the mounting set comprising a removable connection according to an embodiment of the present invention.

FIG. 7 is a second exploded view of the cylindrical container in conjunction with the mounting set comprising a removable connection according to an embodiment of the present invention.

FIG. 8 is an exploded view of a circular ring configured as a first alternative embodiment of a clamping mechanism connection in accordance with the present invention.

FIG. 9 is an exploded view of the circular ring configured as a second alternative embodiment of a clamping mechanism, with an optional illustration for connection to the cylindrical container.

FIG. 10 is an exploded view of a clamping mechanism according to an embodiment of the present invention.

FIG. 11 is a front view of a clamping mechanism according to another embodiment of the present invention.

FIG. 12 is a perspective view of a clamping cover configured as a third embodiment of a clamping mechanism in accordance with the present invention.

FIG. 13 is an exploded view depicting the clamping mechanism cover in accordance with an embodiment of the present invention.

FIG. 14 is a sectioned view that displays the connection between the lid, a clamping mechanism, and the cylindrical container in accordance with an embodiment of the present invention.

FIG. 15 is a perspective view exemplifying an elastic element in accordance with an additional embodiment of the present invention.

FIG. 16 is a sectioned view of the embodiment of FIG. 15.

### DETAILED DESCRIPTION AND BEST MODE OF IMPLEMENTATION

In the following detailed description of the drawings, several embodiments are presented, by means of example, that can be used, combined or added up according to what is most favorable for the construction and usage of the device without limiting the scope of the invention. The terminology employed in the following description is utilized as an illustration and is not intended to be limiting. The cooling device depicted in the following figures may include other components or features that complement the present innovation creating an exhaustive gadget.

The cooling device is presented as a complement to optimize the function of a kitchen appliance that predominantly includes a rotary motor, a container, a lid, a function control panel, and a base; Therefore, in the present description of the following figures, said device is described as an example of an additional accessory for any model, size or type of conventional blender because it is one of the most used kitchen appliances in households around the world.

The figures also illustrate a variety of beverage containers, which are the most commercially prevalent on the market. Therefore, said products will be presented in the graphics, as an example, and do not limit the size, dimension, or type of packaged drink on the market or, in general, any packaged beverage that may exist. These beverage containers may include aluminum cans (20) of 0.266, 0.355, or 0.473 liters (9, 12, or 16 ounces); glass bottles (30) of 0.325 liters (11 ounces); wine bottles of 0.739 liters (25 ounces), for example; or other varieties of containers.

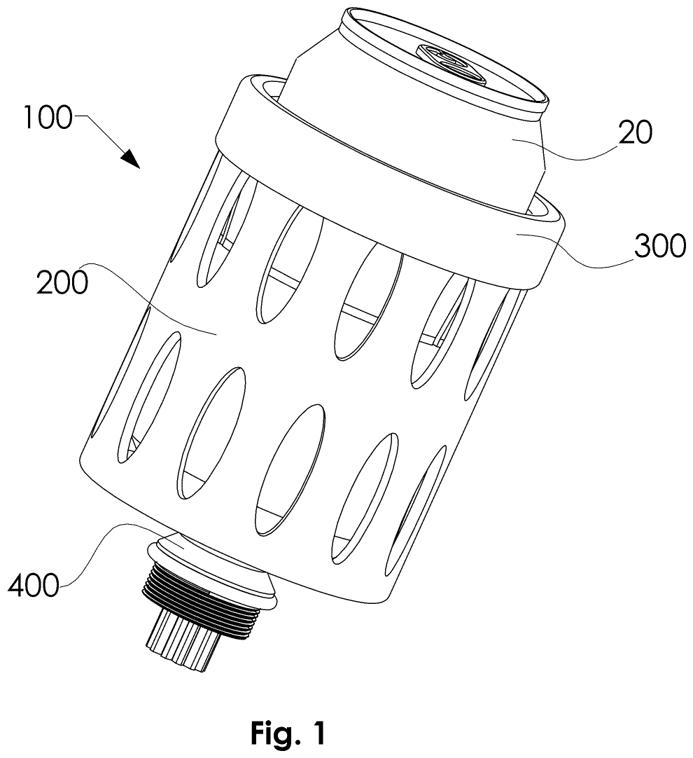

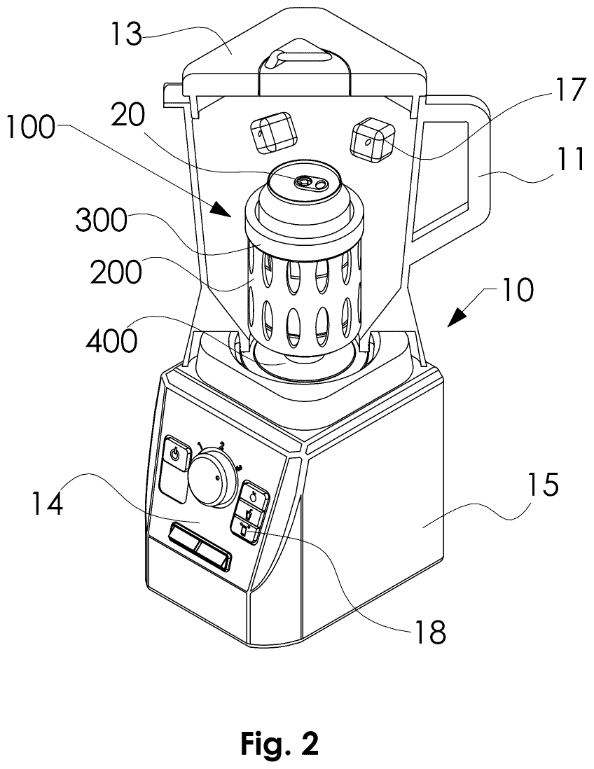

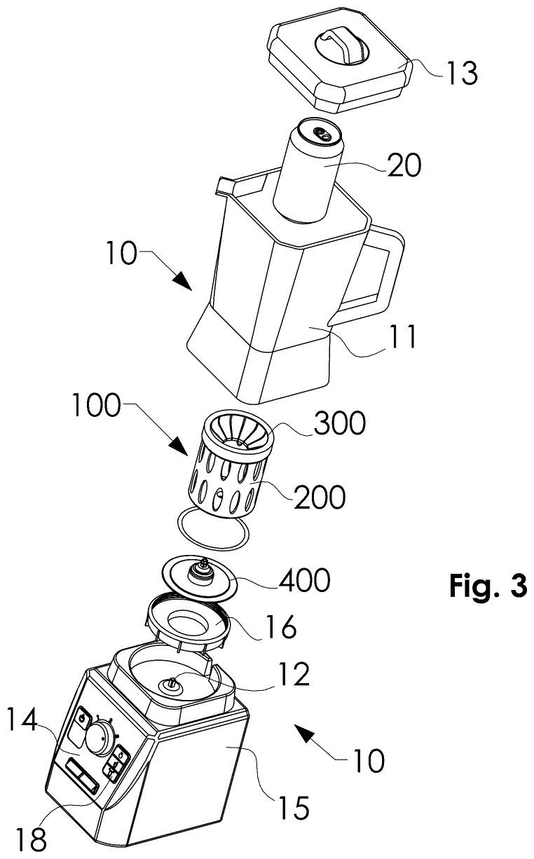

FIG. 1 of the present invention illustrates a device (100) for rapid cooling of packaged beverages (20) that comprises a cylindrical container (200) where the packaged beverage (20) to be cooled is introduced and positioned. Said cylindrical container (200) has at least one clamping mechanism (300) that supports and secures the packaged beverage (20) inside the cylindrical container (200), which is coupled to the receptacle (11 in FIG. 2) of the household appliance (10 in FIG. 2) through a mounting set (400) that spins following the vertical axis of the rotary motor (12 in FIG. 3) of the household appliance (10 in FIG. 2) centering the packaged beverage (20) so that it twirls at the time of activation of the rotary moto (12 in FIG. 3) of the household appliance (10 in FIG. 2) which, as previously mentioned, is represented in the figures as a blender.

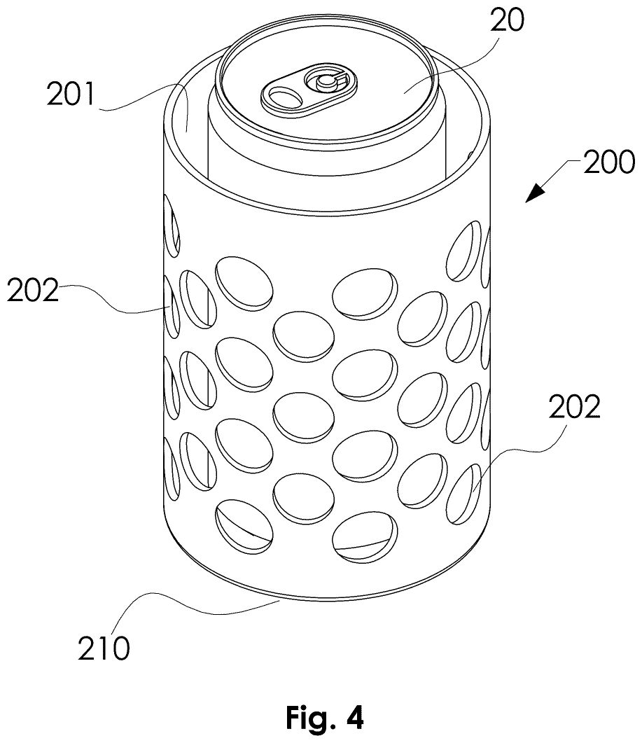

Therefore, in FIGS. 2 and 3, a conventional blender is illustrated, which represents the household appliance (10), which mainly comprises a receptacle (11), a rotary motor (12 in FIG. 3), a lid (13), a function control panel (14) and a base (15). It is worth mentioning that a household machine generally includes blades or accessories that can be exchanged for another component adapted to the machine itself. Then, the blades or the accessory are changed for the device (100) of the present invention so that it can fulfill its purpose. To be precise, the cylindrical container (200) is integrated in a fixed or removable way to an assembly base (210 in FIG. 4) that connects with the mounting set (400) and is positioned inside the receptacle (11) and, adjusted by means of a threaded retaining ring (16 in FIG. 3). The receptacle (11) sits on the base (15) and fits on the vertical axis of the rotary motor (12 in FIG. 3) that is inside the base (15).

Within the receptacle (11) of the household appliance (10), the packaged beverage (20) is positioned and fits inside the cylindrical container (200) through the clamping mechanism (300). Said receptacle (11) is filled with a refrigerant medium (17) that is made up of a mixture of water and ice, which spins when the rotary motor (12 in FIG. 3) of the household appliance (10) is triggered, creating a whirlpool (vortex effect) so that a rapid cooling effect is generated in the packaged beverage (20). Optionally, salt can be added to the ice-water mixture to improve the result. The receptacle (11) is closed with the lid (13) of the household appliance (10), avoiding spillage when the rotary motor (12) is activated.

The rotary motor (12 in FIG. 3) of the household appliance (10) is activated and deactivated utilizing a command (18) with a specific routine that is configured within the function control panel (14), which is generally located on the front part of the base (15) of the household appliance (10). The packaged beverage (20) can be removed upon completion of the specified routine, and a new packed drink can be inserted to repeat the cooling process. The device (100) may also be disassembled at the end of the refrigeration procedure and can be replaced with another of the different accessories mentioned for a user to operate the household appliance (10) again for other functions. Said command (18) can be an additional operation within the function control panel (14) as exclusive usage for cooling of packaged beverages or, alternatively, an existing mandate within the functions of the control panel (14) that includes cycles or intervals in a given time.

As illustrated in FIG. 4, the cylindrical container (200) comprises an upper orifice (201), a set of orifices (202), and an assembly base (210). The upper orifice (201) is disposed at the top of the cylindrical container (200) and may have a diameter of approximately 60 to 70 millimeters, preferably sixty-six millimeters, configured to receive a 0.266, 0.355, or 0.473-liter (nine, twelfe, or sixteen-ounce) aluminum can (20), a 0.325-liter (eleven-ounce) bottle (30), or any similarly-sized container. The upper orifice (201) may also be of a larger diameter in which wine bottles or bigger beverage containers can fit. As to the height of said upper orifice (201), it may be in a range of between five to fifteen centimeters, preferably ten centimeters, taking into account the size of the beverage container, wherein it has an accessible or free part so that a user can easily hold the packaged drink while inserting or removing it from the cylindrical container (200). The set of orifices (202) is arranged around the cylindrical container (200) and distributed in any position, provided that at least one edge of the cylindrical container (200) remains free to be able to couple the clamping mechanism (300). This set of orifices (202) is configured so that the packaged beverage (20) directly contacts the refrigerant medium (17 in FIG. 2), generating a turbulent rotation to it, increasing the possibilities of producing a thermal exchange between the refrigerant medium (17 in FIG. 2) and the packaged beverage in a faster way. Each heat exchange orifice (202) of the cylindrical container (200) may comprise any desired shape and configuration, such as some rectangular, triangular, cylindrical, or similar forms, or as shown in certain figures, in an oval shape or other drawings with a circular pattern.

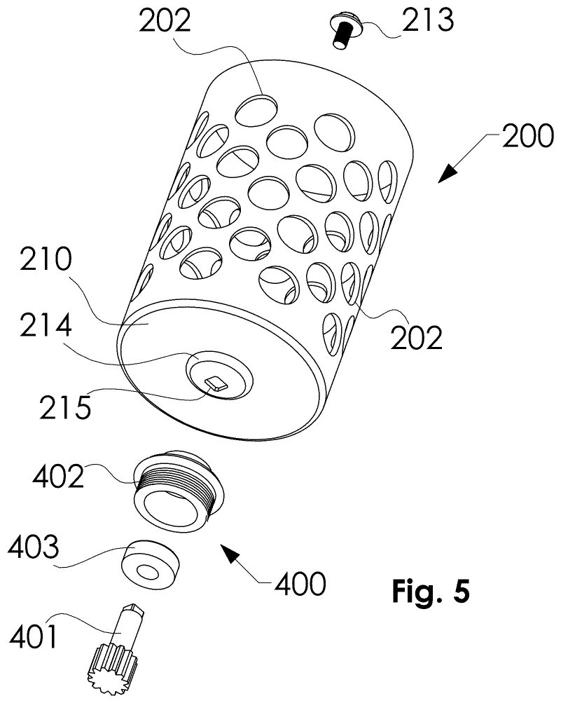

As illustrated in FIG. 5, the assembly base (210) may be configured as a single piece integrated to the cylindrical container (200). In this example, it can be observed that the cylindrical container (200) comprises an upper orifice (201), a set of thermal exchange orifices (202), and, in addition, the assembly base (210) arranged at the bottom of the cylindrical container (200) creating a single integrated element.

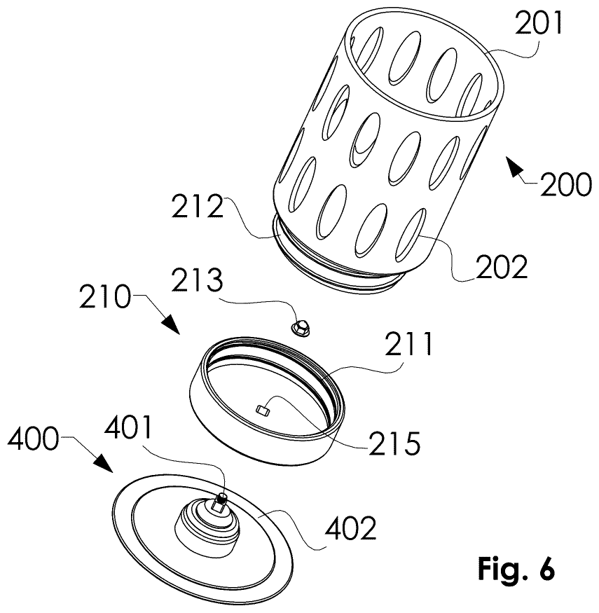

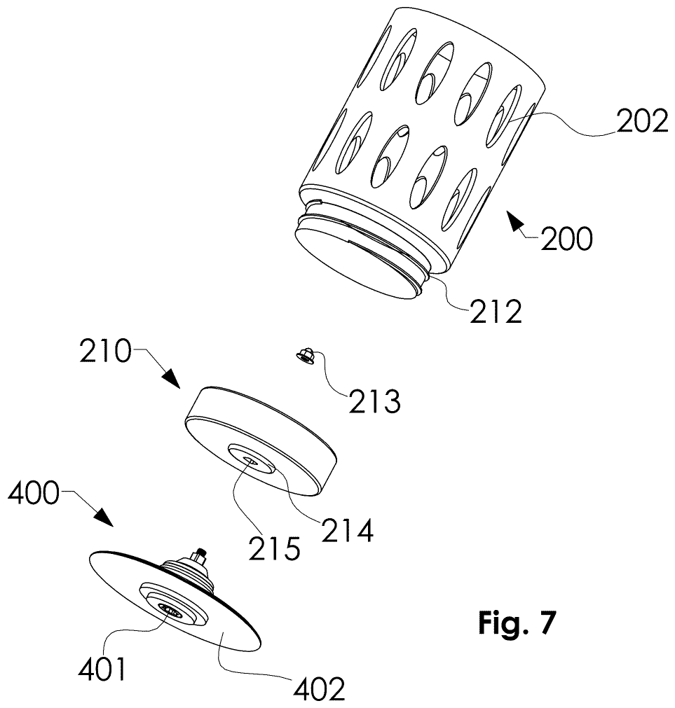

In FIGS. 6 and 7 the assembly base (210) is integrated to the cylindrical container in a removable manner. In this example, the assembly base (210) and the cylindrical container (200) are parts merged by means of an internal and external threaded connection. The internal threaded mechanism (211) is arranged on the assembly base (210), and an external threaded mechanism (212) is placed on the bottom of the cylindrical container (200) or vice versa, allowing them to be joined in both directions. Such an internal and external threaded bond, may be configured for some types of appliances that have the need to insert the mounting set into the household appliance and subsequently must connect the cylindrical container to the mounting set.

An embodiment of the present invention is illustrated in FIGS. 5, 6, and 7, wherein the assembly base (210) is coupled through a fastener element (213) to the mounting set (400). Said fastener element (213) may be: a hook, such as, for example, screws, nuts, rivets, bolts, a quadrant arm stay, or simply a welding process that joins the assembly base (210) to the mounting set (400). Accordingly, said assembly base (210) comprises a central flange (214) disposed on the underside of the assembly support (210) with an opening (215) passing through the central portion of such assembly base (210) to engage the fastener element (213) to the mounting set (400).

As mentioned above, there is currently a great variety of household appliances. Therefore, the present invention seeks that the mounting set (400) can be configured according to the need and convenience of the type of device to be used and that, in addition, it might also be possible to interchange accessories so that a user can operate a kitchen instrument for one or more functions (for example, chopping, blending, cooling drinks, among others). In this way, a suitable complement gets developed for households or food establishments, for instance. Consequently, in some figures, a mounting set is depicted as a way of illustration, nevertheless, said mounting set can be elaborated in any shape, size, material, or type of support body that fits the sort of appliance used for the proper function of the present invention.

According to FIGS. 1, 2, 3, 5, 6, and 7, it can be seen that the mounting set (400) predominantly comprises a mobile piece or axis (401) of any type, size, or shape. It can also be observed that at one end, it engages with the vertical axis of the rotary motor (12) of the household appliance (10), and at the other end, it interlocks with the fastener element (213) of the assembly base (210), transmitting the rotational force to the cylindrical container (200). Said mounting set (400) may also comprise a fixed piece (402) of any type, size, or shape, wherein the receptacle (11) is seated and is adjusted both with the threaded retaining ring (16) and with at least one bearing (403), of any type, size or shape, so as to connect the mobile piece (401) and the fixed piece (402) allowing rotational movement without friction between them. The mounting set (400) may comprise a female or male connection fitted to the mobile piece (401), configured to engage with the vertical axis of the rotary motor (12) of the household appliance (10) being aligned with each other so that the movement, is determined by the motor (12) rotation.

The present invention comprises at least one clamping mechanism (300). Said clamping mechanism (300) is configured to hold any variety of packaged beverages like the ones previously mentioned. Such clamping mechanism (300) is positioned within the cylindrical container (200) either snap-fitted, glued, riveted, screwed or assembled to said cylindrical container (200). Following that, we present some embodiments which may be of great utility for the construction of the clamping mechanism (300) of the present invention. These embodiments may be used, combined or added, according to what is most beneficial for the construction and usage of the device without limiting the scope of the invention.

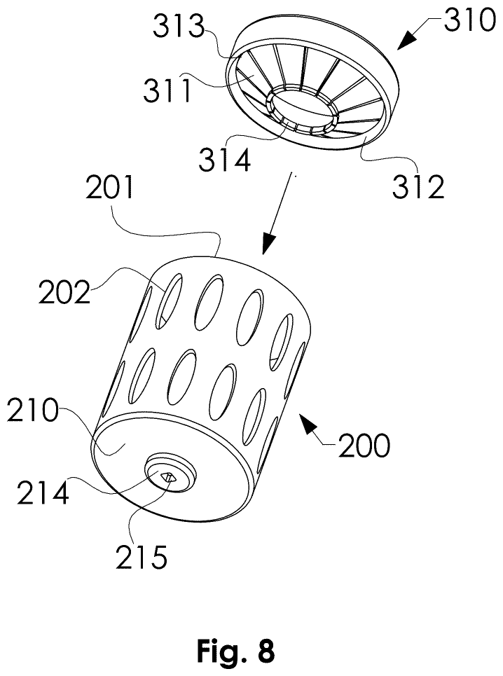

A first alternative embodiment for the clamping mechanism (300) is illustrated in FIG. 8, wherein a circular ring-shaped body (310) is configured, which, in its central part, comprises a set of tabs (311) that extend downwardly from the inner diameter towards the center of the circular ring (310) where the packaged beverage (20) is pressed. In this alternative embodiment, the mentioned circular ring (310) can be fitted to the outer edge of the cylindrical container (200) by means of a perimeter tab (312) so that the packaged beverage (20) is tightly fitted and secured. The set of tabs (311) comprises a fixed end (313) extending to a mobile end (314). The fixed end (313) is located on the perimeter surface of the circular ring (310), and the mobile end (314) forms a downward angle away from the boundary surface of the circular ring (310), tightening the packaged beverage (20).

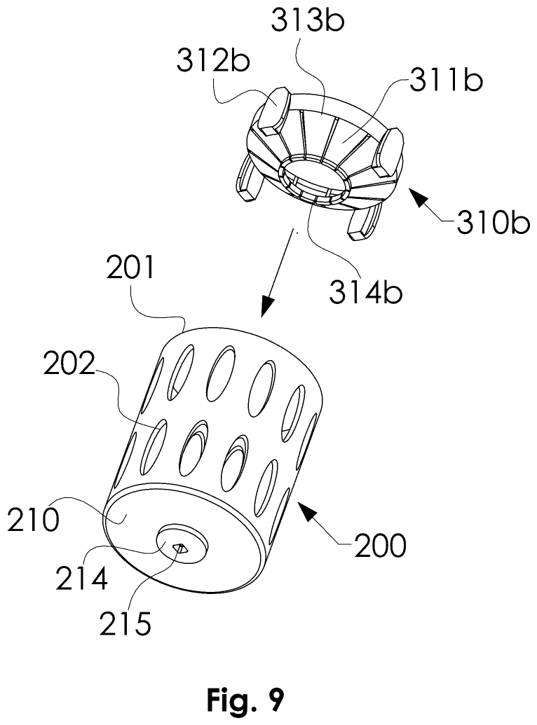

A second alternative embodiment for the clamping mechanism (300) is illustrated in FIG. 9, featuring a circular ring-shaped body (310b) whose central portion comprises a set of tabs (311b) extending downward from the inner diameter towards the center of the circular ring (310b), where the packaged beverage (20) is pressure-secured. In such an alternative embodiment, the circular ring (310b) may be secured by adjustment tabs (312b) which pass through the set of heat exchange orifices (202). The set of tabs (311b) includes a fixed end (313b) and a mobile end (314b), the fixed end (313b) being disposed on the perimeter surface of the circular ring (310b) and the mobile end (314b) forming a downward angle away from the perimeter surface of the circular ring (310) adjusting the packaged beverage (20). The set of tabs (311) (311b) may preferably be made of a flexible polymer or elastomer that allows the user to easily insert the packaged beverage (20) into the cylindrical container (200) and subsequently remove it with ease. This element may be made of a rubbery material such as synthetic rubber, natural rubber, or silicone, among others.

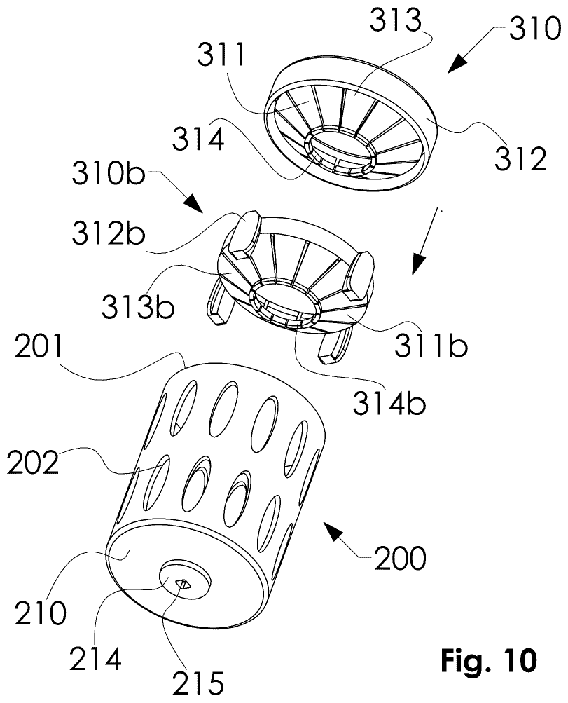

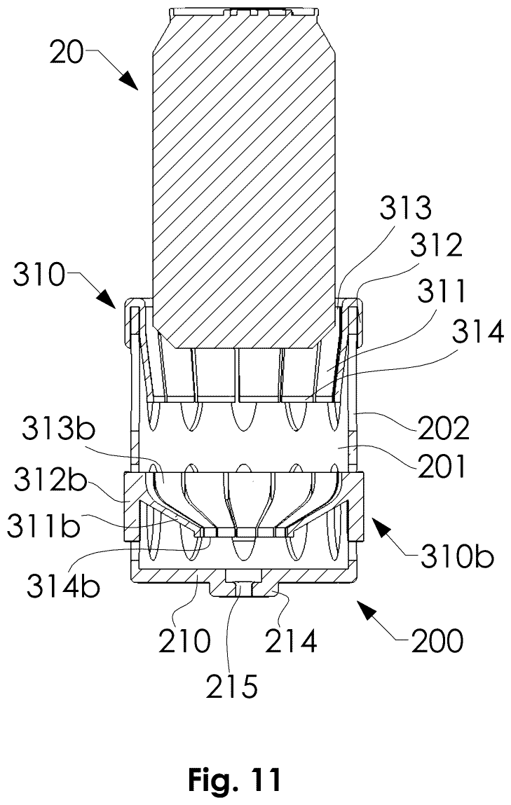

Taking into account that, in the present invention, one, two or more clamping mechanisms can be configured, FIGS. 10 and 11 depict a second circular ring assembled with the same characteristics of the first circular ring and with that of the first alternative embodiment illustrated in FIG. 8, where the circular ring (310) includes a perimeter tab (312). On the other hand, said second circular ring can also be constructed with the second alternative embodiment illustrated in FIG. 9, where the circular ring (310b) comprises clamping tabs (312b). According to FIGS. 10 and 11, the two mentioned embodiments can be used or combined, or configured in the most convenient way for the production of the present invention, which means that such second ring can be designed with any of the two embodiments of clamping mechanism mentioned above. A second clamping instrument can benefit the current innovation since, for instance, the two circular rings (310) and (310b) can adjust and grip the packaged beverage (20) more firmly, which can even be higher than a traditional packaged drink, such as a 16-ounce can of beer, a bottle of wine, or just a large container.

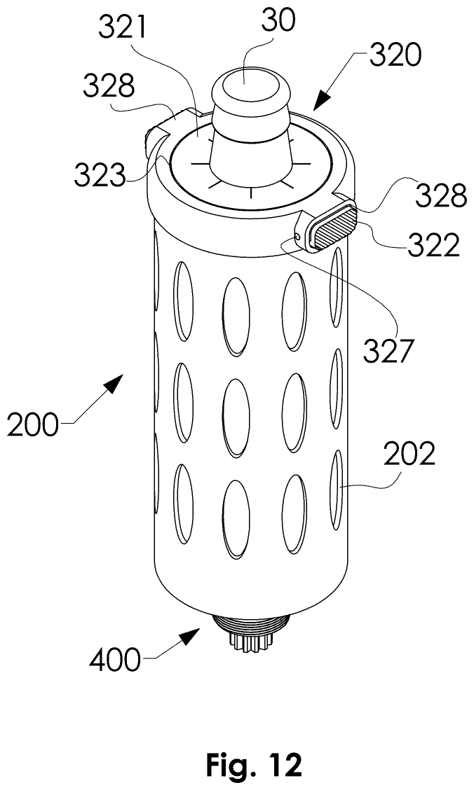

A third alternative embodiment for the clamping mechanism (300) is illustrated in FIGS. 12 to 16. This realization consists of a clamping cover (320) comprising a central orifice (323) where a set of tabs (321) sits. The latter extends from the edge of the clamping cover (320), curving upwards when the packaged beverage is pressed. The bottled drink is represented now by a glass bottle (30). Said clamping cover (320) can be adjusted on the upper edge of the cylindrical container (200) by a locking means (322) so that the glass bottle (30) is adjusted and secured. The mentioned cylindrical container (200) can include a notch (203) that receives the locking means (322) with the clamping cover (320) for a perfect locking.

The set of tabs (321) comprises a fixed end (324) extending to a mobile end (325), the fixed end (324) is arranged on the perimeter surface of the central orifice (323) of the clamping cover (320), and the mobile end (325) forms an upward angle away from the perimeter surface of the clamping cover (320) adjusting the packaged beverage or bottle (30). The central orifice (323) is configured so that the neck of a bottle (30) enters and that the set of tabs (321) can enclose said bottle, causing it to rotate at the same time as the cylindrical container (200). The mentioned set of tabs (321) can preferably be made of a flexible material, such as an elastomeric polymer, or a rubbery material like synthetic rubber, natural rubber, or silicone, among others. The objective is that it takes the shape of the neck of the glass bottle (30) without requiring great efforts by the user when introducing said bottle (30) through the central orifice (323) and that it can be easily removed later. The clamping cover (320) can be elaborated of a rigid, semi-rigid polymer or a plastic such as high-density polyethylene, PVC, ABS, or others.

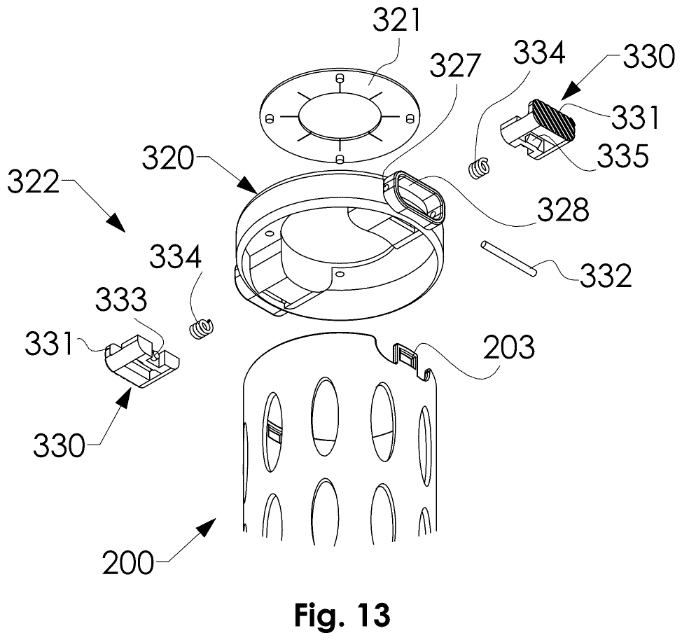

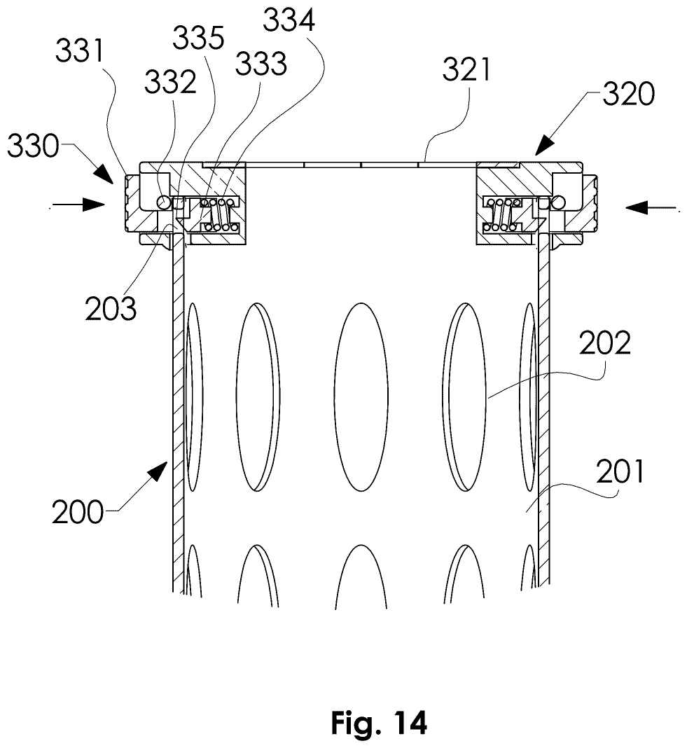

FIGS. 13 and 14 illustrate as an example a locking means (322) of the clamping cover (320) that comprises at least two push buttons (330) that engage in the notch (203) on the upper edge of the cylindrical container (200). Each push button (330) comprises a contact surface (331) configured so that a user can depress the push button (330) to allow the clamping cover (320) to be released; a pin (332) that confines or limits the movement of the push button (330) through the clamping cover (320) across a hole (327); an axis (333) on which a spring (334) seats so that the push button (330) is returned to its confinement place when a user releases the contact surface (331) securing the clamping cover (320) against the cylindrical container (200) and a stop (335) that blocks the exit of the clamping cover (320) when the packaged beverage (20) is inside the cylindrical container (200). Each push button (330) is arranged in a cavity or channel (328) of the clamping cover (320), where it is secured with the stop (335) when inserted into the notch (203) provided inside the cylindrical container (200). As shown in the figures, two push buttons (330) can be configured to surround the clamping cover (320), preferably one in front of the other, so that a user can press them at the same time and release said clamping cover (320). It must be taken into account that the additional embodiment can be configured with any other locking means that can be used in the present invention or that other pieces or mechanisms can be combined or added to improve the connection between the cylindrical container (200) and the clamping mechanism (300), for achieving the purpose of the current innovation.

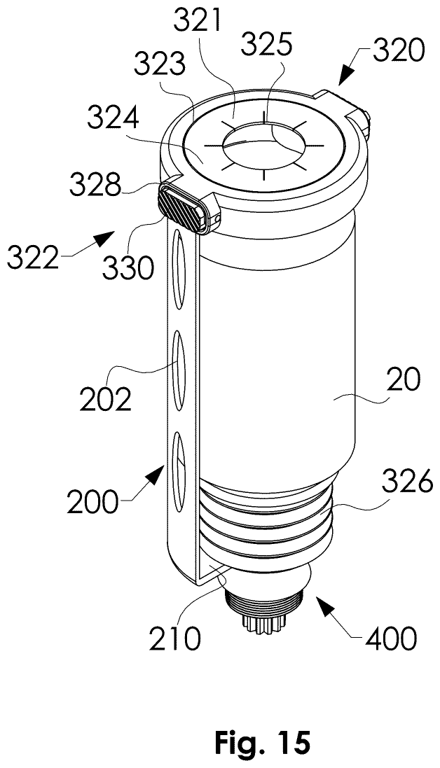

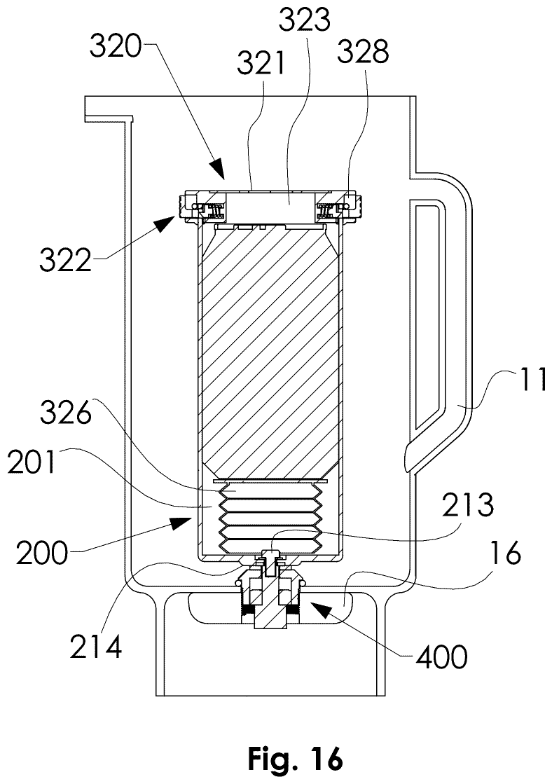

Continuing with the third alternative embodiment, and taking into account that packaged beverages vary considerably in terms of sizes and heights, the present invention additionally includes an elastic element (326) that can be a spring, a spring suspension, or a rubber bellows, illustrated in FIG. 15 (in more detail in FIG. 16, which is a section view of FIG. 15, located in the lower internal part of the cylindrical container (200). Said elastic element (326) is configured so that, when the moment of adjusting the clamping cover (320) against the cylindrical container (200), the elastic element (326) can press any type of packaged beverage, in this case, the aluminum can (20), without moving from its position regardless of how high it is. Said spring or elastic element (326) can be connected to the assembly base (210) by means of a fixing medium, avoiding the movement of its position while the vertical axis of the rotary motor (12) is rotating. The rubber bellows is the preferred material for the elaboration of said additional embodiment, since it is more resistant to water, but any spring can also be used, for example, with a plastic coating or any elastic element that meets the above-mentioned characteristics.

The current invention has been described considering the most practical and preferred embodiments concerning the present time. It should be considered that this innovation is not limited to the realizations and configurations described above; instead, they are intended to cover different modifications and arrangements included in the scope thereof. Moreover, the illustrations previously described may be complemented by other embodiments and create additional ones to assemble the present invention.

The description as set forth is not intended to be exhaustive or to limit the invention to the precise form disclosed. Many modifications and variations are possible in light of the teachings above without departing from the spirit and scope of the forthcoming claims.

1. A rapid cooling device for bottled beverages, comprising a cylindrical container, said cylindrical container comprising:
an upper orifice;
a set of heat exchange orifices arranged around said upper orifice; and
an assembly base;
said assembly base comprising a central opening where a fastener element is placed;
wherein said cylindrical container couples to a mounting set; and
wherein said cylindrical container couples to at least one clamping mechanism;
said clamping mechanism comprising a set of clamping tabs;
wherein each clamping tab comprises a fixed end located on a perimeter surface of the clamping mechanism; and
wherein each clamping tab extends to a mobile end.

2. The rapid cooling device according to claim 1, wherein the cylindrical container is removably coupled to the assembly base via an internal and external thread.

3. The rapid cooling device according to claim 1, wherein least one clamping mechanism is a circular ring having a center, an outer diameter and an inner diameter, wherein the set of tabs extends downward from the inner diameter toward the center of the circular ring and is pressure-fitted by a perimeter tab to an outer edge of the cylindrical container.

4. The rapid cooling device according to claim 1, is a circular ring having a center, an outer diameter and an inner diameter, wherein the set of tabs extends downwardly from the inner diameter towards the center of the circular ring and is pressure-fitted from inside the cylindrical container through heat exchange orifices via adjustment tabs.

5. The rapid cooling device according to claim 1, wherein the clamping mechanism comprises a clamping cover; said clamping cover comprising a central orifice which extends to the set of tabs and a locking means.

6. The rapid cooling device according to claim 5, wherein the cylindrical container comprises a notch configured to receive the locking means, securing the clamping cover to the cylindrical container.

7. The rapid cooling device according to claim 6, wherein the locking means comprises at least two push buttons positioned opposite each other, wherein said push buttons are pressed to release the clamping cover from the cylindrical container.

8. The rapid cooling device according to claim 7, wherein each push button comprises a stop that locks the clamping cover when inserted via a spring into the notch of the cylindrical container, and releases said clamping cover when the locking means is pressed.

9. The rapid cooling device according to claim 8, further comprising an elastic element arranged on the cylindrical container.

10. The rapid cooling device according to claim 1, wherein the device parts are made from materials selected from the group consisting of stainless steel, plastic, or aluminum.

11. The rapid cooling device according to claim 5, characterized in that the set of tabs of the clamping mechanism are made from materials selected from the group consisting of elastomeric polymers, silicones, synthetic rubbers, or natural rubbers.
